(19) United States
(12) Patent Application Publication
(10) Pub. No.: US 2005/0051008 A1
(43) Pub. Date: Mar. 10, 2005

(54) Device for controlling the outward movement of the cutting blade of a drum in a wiping material dispenser

(76) Inventor: Maurice Granger, Saint Priest En Jarez (FR)

Correspondence Address: HESLIN ROTHENBERG FARLEY & MESITI PC, 5 COLUMBIA CIRCLE, ALBANY, NY, 12203, US

(21) Appl. No.: 10/933,047

(22) Filed: Sep. 2, 2004

(30) Foreign Application Priority Data
Sep. 5, 2003 (FR) 0310626

(51) Int. Cl. B26D 1/56

(52) U.S. Cl. 83/335; 83/337; 83/649; 83/937

(57) ABSTRACT

A device for controlling outward movement of a cutting blade of a drum in wiping material dispensing equipment is distinctive in that one of the flanges of the casing is designed with elements means having a fixed position and formed during molding of an inner side of the flange facing the drum and being applied against a facing edge of the drum. The end flange of the drum on its lateral edge has a projecting profile forming a bar arranged for the fixing and pivoting of the blade holder and having a cutout to receive a locking member formed on a lever mounted to pivot with the blade holder. Each of an element and the lever located on the flange and the drum, respectively has two shaped protuberances which interact at certain stages of operation. One of the elements formed on the flange is designed to interact with the locking member formed on said lever at certain stages of operation when the drum rotates.

The invention relates to the technical field of equipment for dispensing wiping materials' such as paper or the like for wiping the hands or for use as toilet paper, the strip of material being in a folded or unfolded position.

The principle of this equipment was defined in the applicant's French patents FR 2332215 and 2340887, particularly as regards the device for controlling and moving the cutting blade into and then out of the drum in order to cut the strip of material pulled by the user.

To enable the field of the invention to be understood, it will be briefly mentioned that a piece of equipment of this type comprises a casing receiving a protective cover. The upper part of this casing receives supporting arms of a wiping material reel holder. In the lower part of the casing, a drum is fitted so that it can rotate freely between supporting flanges, and is designed to receive a cutting device comprising a blade and a blade holder inside the drum, which moves out of the drum for cutting. In the French patents cited above, a cam device is provided on one side of the drum and comprises a cam associated with the shaft of the drum and a cam follower associated with the axis of the blade holder, enabling the blade to move outwards when the drum rotates. A specific embodiment of the patent FR 2340887 also provides a cam slot formed on the flange of the drum receiving the cam follower.

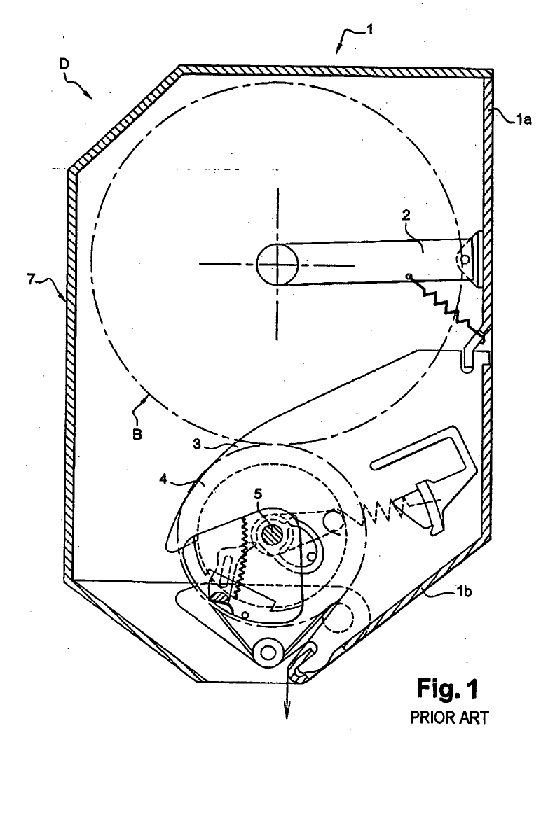

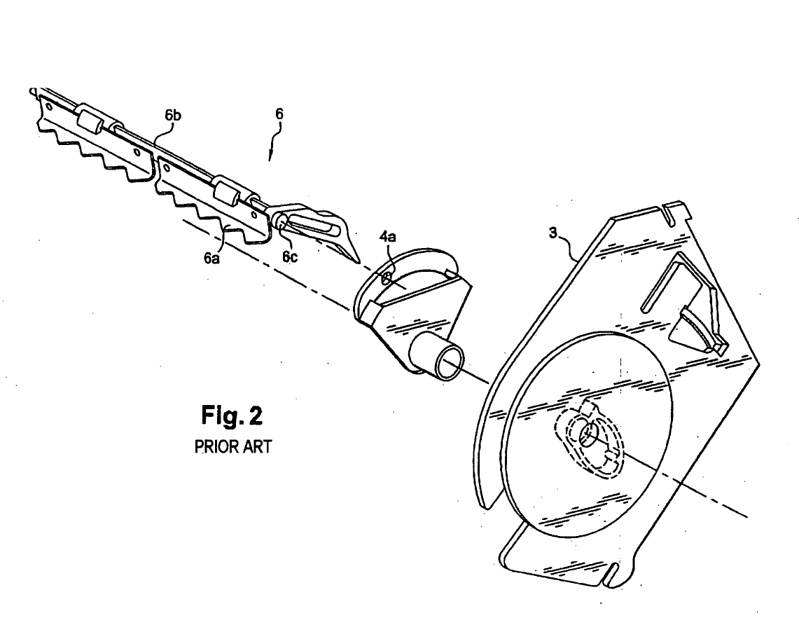

To tackle the problem posed by the variations in quality and thickness of the reels of wiping material, and to improve the cutting, the applicant has developed a design of the device for controlling the outward movement of the blade described in PCT patent WO 00/40132. In this document, the device comprises, on one of the flanges and around a ring for the passage of the locking axis of the drum, a fixed profile -forming a single unit with the body of the flange, constituting a guide path for a complementary part associated with the blade holder, said fixed profile and said complementary part having projecting profiles in the form of teeth to interact with each other when the drum rotates, creating an amplitude effect in relation to the movement of- the part forming a lever when it swings, thus facilitating the cut. Said shape of the complementary part is thus shown in FIGS. 1 and 2 to make its configuration clear. The cutting blade is therefore subjected to a movement out of the drum and then back into it, as a result of the position of the single-unit part associated with the blade holder with respect to the fixed profile forming the cam. In this embodiment, the blade holder requires the use of an elastic return spring.

The solution described in this PCT patent WO 00/40132 is entirely satisfactory when the diameter of the drum of the dispensing equipment is made to dispense material with a format of 13 inches. However, when smaller formats are required, of the order of 11 inches for example, difficulties have been encountered in pulling the strip of material, these difficulties being increased by the variable quality and thickness of the reels of material.

Since said dispensing equipment with automatic cutting must have the best possible performance in view of its conditions of use, the applicant has sought a solution to further improve the operation of this type of equipment, in order to provide a high quality of operation for dispensing and cutting strips of wiping material in small formats, for example of the order of 11 inches or less.

As part of the same process and in the same context, the applicant wished to make the equipment even quieter by suppressing the clicking which occurs in particular when the cutting blade returns into the drum, as a result of the noise due to the stress of the return spring associated with the blade holder and incorporated in the drum.,

These objects and others will be made clear by the remainder of the description.

According to a first characteristic, the device for controlling the outward movement of the blade is distinctive in that one of the flanges of the casing for fixing the drum is designed with means having a fixed position, formed during the molding of the inner side of the flange facing the drum and being applied against the facing edge of the drum, and in that the end flange of the drum on its lateral edge has a projecting profile forming a bar designed for the fixing and pivoting of the blade holder and having a cutout to receive a locking means formed on a fitted lever which is pivoted with the blade holder, and in that the each of the formed means located on the flange and the drum has two shaped protuberances which can interact with each other at certain stages of operation, and in that one of the means formed on the flange is designed to interact with the locking means formed on said lever at certain stages of operation when the drum rotates.

These characteristics and others will be made clear by the remainder of the description.

To specify the object of the invention illustrated without restrictive intent in the figures of the drawings in which:

FIG. 1 shows a side view and dispensing equipment according to the prior art, conforming to the teaching of the aforesaid PCT patent.

FIG. 2 is a perspective view of the device for controlling the outward movement of the blade in the prior art, conforming to the teaching of the aforesaid PCT patent.

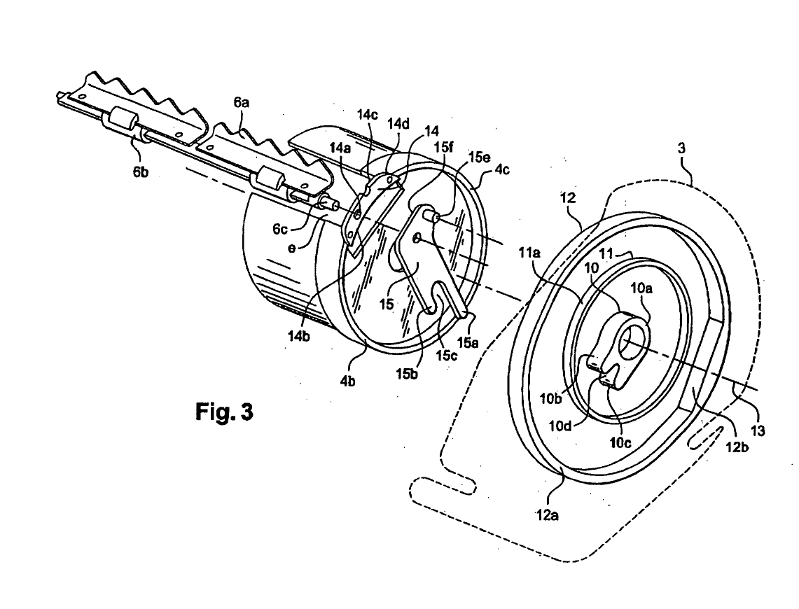

FIG. 3 is an exploded perspective of the device for controlling the outward movement of the blade according to the invention.

FIG. 4 is a plan view of the casing flange for receiving the fixed means formed during molding.

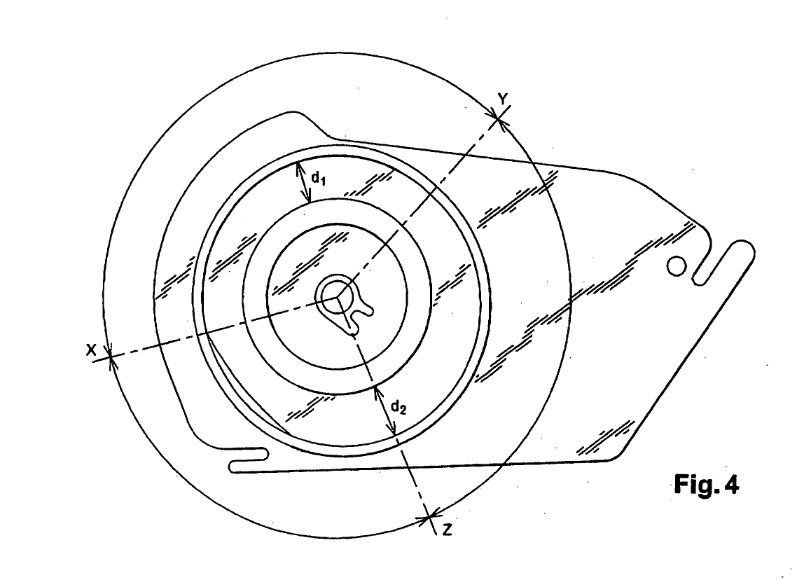

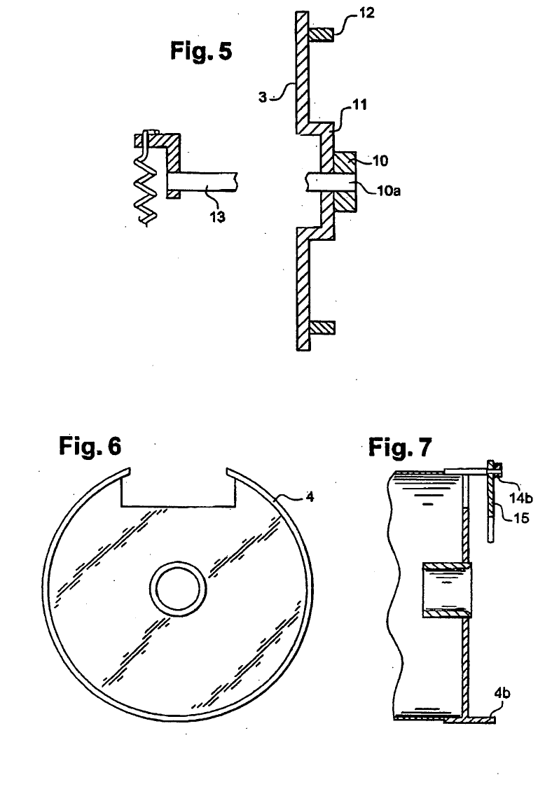

FIG. 5 is a partial sectional view of said flange.

FIG. 6 is a view from the side of the drum.

FIG. 7 is a partial view of the end of the drum.

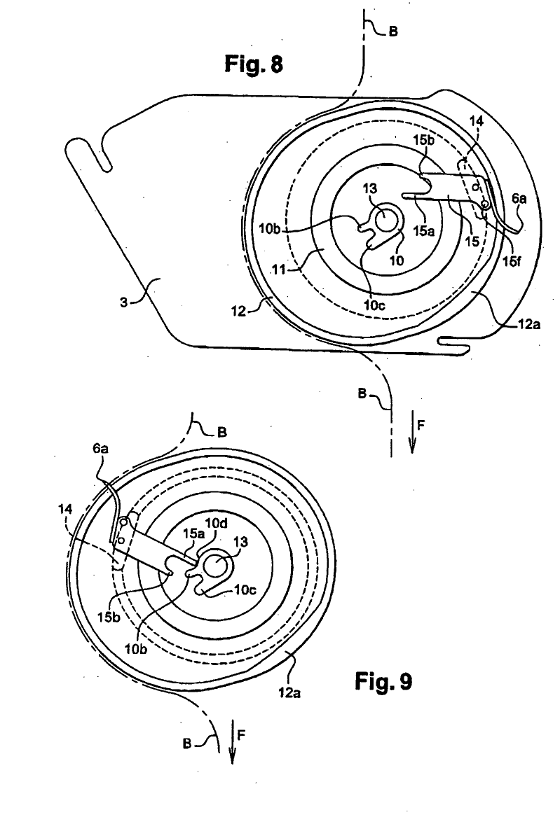

FIGS. 8 to 15 show the various stages of operation of the device according to the invention.

In order to make the object of the invention clearer, it will now be described as illustrated without restrictive intent in the figures of the drawings.

What is represented is dispensing equipment (D) for wiping materials, only the parts essential to the understanding of the invention being shown. The equipment comprises a casing, (1) having a vertical base surface (1a) extended in its lower part by an inclined plane (1b). Reel holder arms (2) are mounted on and project from the base surface to receive the reel (B) of wiping material. One of the arms can be pivoted with the aid of a spring so that the reel can be positioned. Lower flanges (3) are mounted and fixed on the inclined plane of the casing in any appropriate way. A drum (4) is positioned between the flanges of the casing in a known way, and is mounted in a freely rotatable way by means of shafts (5) connected to the aforesaid flanges. The drum is designed in any known way, particularly according to the applicant's patents.

The drum receives a cutting device (6) comprising a blade holder (6b) and a blade (6a), the blade holder being pivoted by end shafts (6c) inserted into apertures (4a) formed in or near the lateral ends of the drum. These ends are designed in the form of flanges (4b). It is pointed out that the wiping reel can either bear directly on the drum or be suspended by the reel holder arm without contact with the drum. The strip of material is guided, regardless of the chosen variant, behind the drum, in the base part of the casing, so that it can be cut when the cutting device moves outwards-beyond the outer circumference of the drum. The strip of material exits from the lower part of the equipment. A protective cover (7) keeps the equipment closed.

The characteristics of the device for controlling the outward movement of the cutting blade according to the invention will now be described.

This device includes a special arrangement on one of the lower flanges (3) of the casing carrying the drum and a complementary special arrangement on the facing end part or flange (4b) of the drum.

The flange (3) of the casing is thus designed with a combination of several means (10-11-12) in fixed positions, formed during the molding of the inner side of said flange facing the drum. These means (10-11-12) can interact by engagement and by guiding, during the stages of operation of the device, with two complementary means provided and positioned so that they project from the transverse edge (4c) of the facing end flange (4b) of the drum (4).

More specifically, the flange (3) of the casing comprises a first central means (10) made in the form of a ring (10a) for the passage of the locking axis (13) of the drum (4), this ring having on its periphery two substantially adjacent shaped protuberances (10b-10c) between which a space (10d) is provided, the two protuberances having some of the characteristics of teeth. The height of the first protuberance (10b) is significantly greater than that of the second protuberance (10c). Said space (10d) is provided to permit the passage of one of the means positioned on the drum, as explained below.

Around said first means (10) there is positioned the second means (11) made in the form of a projecting ring, concentric with the axis of the ring (10a) and the locking axis (13) of the drum. The second means (11) has a regular circular shape and its outer periphery (11a) can face, without contact, one of the means provided on the facing edge (4c) of the drum (4). This second means helps to guide one of the means associated with the drum. The third means (12) is provided in the form of a ring having a closed non-circular profile with an eccentric offset part (12a). This ring (12) also has internally and over a section of the order of approximately 25 to 352 a rectilinear flat (12b) forming an area for stopping and pushing a locking means projecting from the drum (4).

As shown in FIGS. 4 and 8 to 15 of the drawings, the ring (12) has a special non-circular profile, with three sectoral areas XY, YZ, ZX which are different from each other, permitting the passage of the lever (15) in the various stages of operation. The angular sector XY which is of the order of 1482 is regularly circular, the sector YZ which is of the order of 1182 has the amplitude and eccentricity, and the sector ZX which is of the order of 942 has a progressive decrease to join and connect with the start of the first area. At the peak point Z of the amplitude of the ring (12), the distance (d2) corresponding to the width between the rings (12) and (11) is approximately 12 mm greater than the distance (d1) on the circular part of the first area. For guidance only, d1=10 mm and d2=22 mm. The peak point Z is located in the extension of the protuberance (10c).

The flange (3) thus formed manufactured directly with its various means (10-11-12) and therefore capable of being applied against the facing edge (4c) of the flange (4b) of the drum (4).

A description will now be given of the different areas formed on the edge (4c) of said end flange (4b) of the drum (4) and interacting with said means (10-11-12) formed on the flange (3).

In the first place, the end flange (4b) of the drum has, directly formed on or applied to its lateral edge (4c), a projecting profile (14) forming a bar and having an aperture (14a) for the passage and introduction of the shaft (6c) of the blade holder (6) to allow it to pivot and thus allow the blade holder to swing. This bar (14) has a substantially curved inner profile (14b) so that it faces the peripheral outer edge of the first ring (11), regardless of the stage of rotation of the drum, forming a guide path between them. Said bar has on its upper face (14e) opposite the lower profile (14b) a cutout (14d) housing a means having a locking function associated with the blade holder.

The blade holder, (6) is designed with a means; (15) positioned in the space (e) formed between the last part of the blade and the projecting, bar surface at the end of the drum. The means (15) is thus located in the proximity of the pivot shaft (6c) of the blade holder with respect to the bar profile. This means (15) is designed in a very distinctive way to permit, on the one hand, the outward movement of the cutting blade by interaction with the means (10) and the protuberances (10c) (10b) in particular, and the inward return of the blade after the cut, being locked in position in the cutout (14d) formed in the bar profile. More specifically, the means (15) is made and shaped to form a lever which is fixed to the blade holder and is therefore closely associated with the latter in its movement. It therefore has in its lower part two protuberances (15a-15b) having very different shapes and dimensions, shaped and spaced apart in substantially parallel planes, with a connecting area (15c). The first, leading protuberance (15a), which is larger, has a triangular configuration, while the second, trailing, protuberance (15b) has a pointed shape and is in a specified ratio of height of the order of 1 to 5. The means (15) also comprises an appendage (15e) whose height is such that it extends beyond the plane of the blade holder. This appendage (15e) has at its upper end a crank (15f) oriented perpendicularly to the plane of the lever and facing the cutout formed in the bar. Thus the cranked profile (15f) can enter or withdraw from the cutout according to the stages of operation of the dispensing equipment, thus providing a locking function.

A description will now be given of the mode of operation of the device in its different stages, with reference to the figures of the drawings.

FIG. 8: The dispensing equipment is not in operation and the cutting blade is withdrawn. In this case, the lever (15) associated with the blade holder is not stressed and is not in contact with the means (10) through its two protuberances (10b-10c). The inner flat formed on the non-circular ring (12) is located in a plane below the bar (14) associated with the drum. The withdrawn cutting blade is located on the front of the equipment. All of the protuberances and/or teeth of the means (10-15) are located towards the rear of the equipment.

FIG. 9: the drum is urged to rotate, according to the arrow (F), by the effect of the user's pulling a strip of material. The drum therefore turns with respect to the supporting flanges (3), and the leading protuberance (15a) of the lever associated with the blade holder is only in contact with the curved face (10d) adjacent to the protuberance (10a). The bar (14) associated with the drum is substantially and diametrically opposed to the flat part (12a) of the flange (3). The second protuberance (10b) does not contact the lever at all.

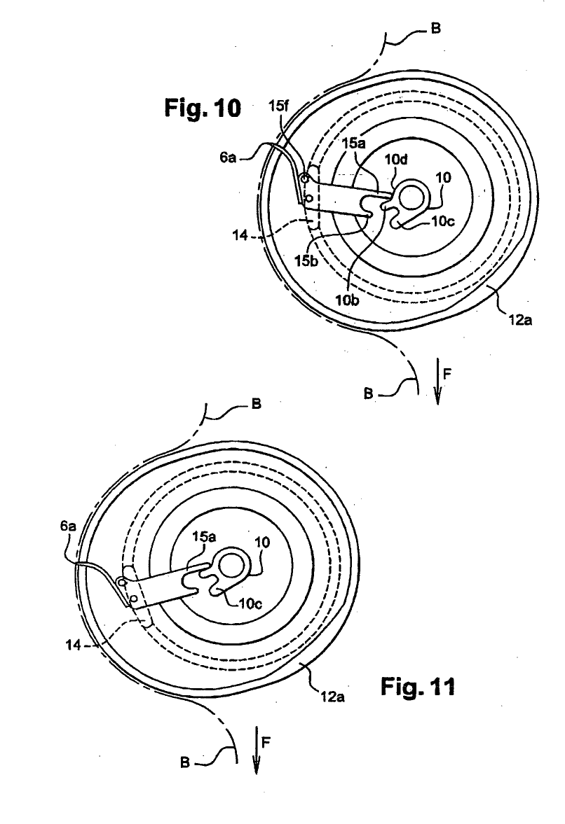

FIG. 10: the rotation of the drum continues to allow the cutting blade to be deployed. The pulled strip of material is stretched and the pointed parts of the blade penetrate into the material. The protuberance (15a) of the lever continues to bear on the protuberance (10a) of the means (10), while the protuberance (15b) still makes no contact. Also in this position, the locking means begins to move out of its housing formed on the bar.

FIG. 11: the rotation of the drum continues as a result of the pulling by the user. The strip of material is still partially pierced. This causes the first protuberance (15a) of the lever to slide backward on the base (10a) of the means (10). The second protuberance (15b) of the lever approaches the second protuberance (10b) of the means (10).

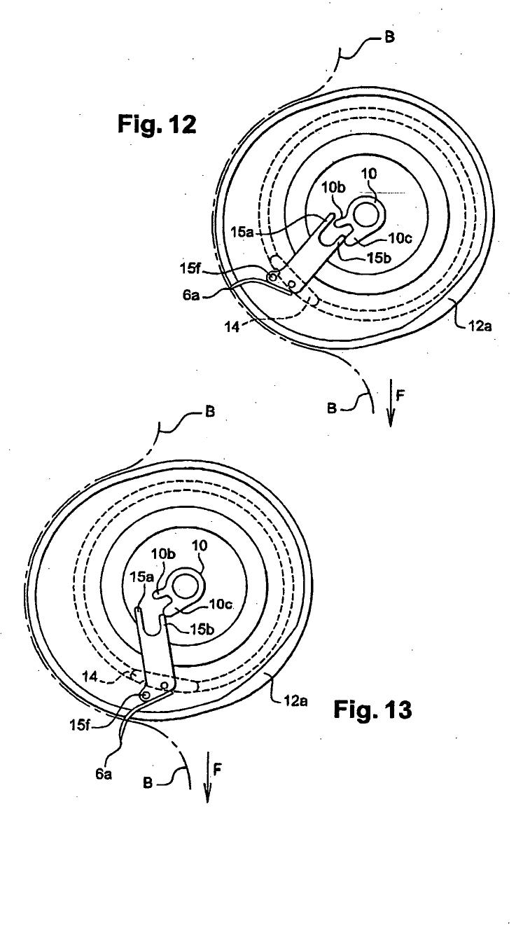

FIG. 12: the rotation of the drum continues with the cutting blade moved outwards by approximately ¾ of its travel; the material is still not completely cut. The first protuberance (15a) of the lever has escaped from the first protuberance (10a) of the means (10), while an initial contact has been created between the second protuberance (15b) of the lever and the second protuberance (10c) of the means (10).

FIG. 13: the rotation: of the drum continues, and the material has been completely cut. The lever (15) has swung completely with a final contact between the second protuberance (15b) and the protuberance (10b).

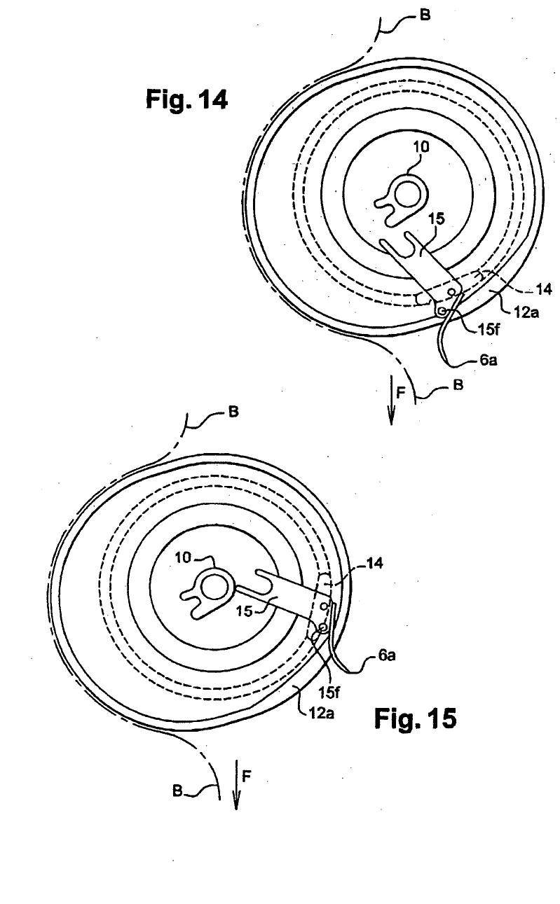

FIG. 14: the drum continues to rotate in this stage, corresponding to the return of the blade. The lever (15) has escaped completely from the means (10), and there is no longer any contact between the protuberances (15a-15b-10b-10c). The flat part (12a) formed on the ring (12) is in contact with the locking means and causes it to return progressively into its housing, with the return swing of the blade.

FIG. 15: the withdrawal of the cutting blade is complete, the locking means with the crank end is again located in the cutout made in the bar (14), and the flat (12a) has returned to the initial position of FIG. 4.

The design described above yields numerous advantages. It is perfectly suited for cutting wiping material in smaller formats of the order of 11 inches or less. The equipment according to the invention operates noiselessly because of the elimination of the return spring of the blade holder of the drum. The guiding provided by the different profiles offers great flexibility and reliability in operation, without noise. The configuration of the non-circular means (12) with its eccentricity is designed to permit satisfactory rotation of the drum during the movement of the blade holder lever associated with the locking means.

With reference to FIG. 5, and without departure from the scope of the invention, the flange (3) of the casing provided with the means (10-11-12) is formed on its outer side with a central void (3e) to minimize the overall dimensions so that it can be incorporated in the casing of the equipment while permitting the passage of a known return means associated with the locking axis (13) of the drum.

The advantages are made clear by the invention. We would emphasize the simplicity of the device and the possibility of manufacturing the various components as molded parts, thus reducing the assembly work.

The present invention was devised to tackle a problem which arose for formats of cut material which might be of the order of 11 inches, but, without departure from the scope of the invention, this invention can be applied for larger formats.

1. A device for controlling outward movement of a cutting blade of a drum in wiping material dispensing equipment, said equipment comprising a casing with cover, said casing receiving arms supporting a reel of wiping material in an upper part, and receiving in a lower part a drum mounted in a freely rotatable way between flanges, the drum being designed to receive a blade holder which is pivoted and moves out of the drum for a cut, the reel of wiping material bearing on or being suspended above a flange of the flanges, said flange having a first ring for passage of a locking axis of the drum, a profile forming a fixed protuberance in a single unit with a body of the flange, said profile being designed to constitute a guide path for a complementary part having a protuberance associated with the blade holder and permitting outward movement of the blade and the cut during rotation of the drum resulting from pulling of a strip of the material by a user, the protuberances being capable of interacting with each other during the rotation of the drum and creating an amplitude effect on movement of the part the part forming a lever during its movement,
wherein said flange is provided with means in fixed positions, formed during molding of an inner side of the flange facing the drum and being applied against a facing edge of the drum,
and wherein the flange of the drum, on its lateral edge, has a projecting form forming a bar, arranged for the fixing and pivoting of the blade holder and having a cutout for receiving a locking means formed on the part forming a lever mounted in a pivoting way with the blade holder,
and wherein each of the profile and the part forming the lever comprises two shaped protuberances which can interact at certain stages of operation,
and wherein the part is made and shaped to form a lever fixed to the blade holder and associated with the blade holder in its movement, and in that the part forming a lever comprises in its lower part two protuberances differing widely in their shapes and dimensions, shaped and spaced apart from each other in substantially parallel planes with a connecting area,
and wherein one of the means formed on the flange is designed to interact with the locking means formed on said part at certain stages of operation during the rotation of the drum.

2. The device as claimed in claim 1, wherein the flange comprises a first central means in the form of a ring for passage of the locking axis of the drum, said ring having on its periphery two substantially adjacent shaped protuberances, between which a space is provided, the two protuberances forming teeth,
and wherein height of a first of said two substantially adjacent shaped protuberances is substantially greater than that of a second of said two substantially adjacent shaped protuberances,
and wherein said space is provided to permit the passage of one of the means on the drum.

3. The device as claimed in of claim 1, wherein around said profile there is positioned a second means made in the form of a projecting ring, concentric with an axis of the first ring and the locking axis of the drum,
and wherein said second means has a regular circular shape and its outer periphery can contact one of means provided on the facing edge of the drum.

4. The device as claimed in claims 1, wherein a third means is provided in the form of a ring having a closed non-circular profile with an eccentric offset part,
and wherein said ring of the third means has internally and over a section of the order of approximately 25 to 35° a rectilinear flat forming an area for stopping and pushing a locking means projecting from the drum.

5. The device as claimed in claim 1, wherein the flange of the drum on its lateral edge has a directly formed or applied projecting profile forming a bar and having an aperture for passage and introduction of an end of a shaft of the blade holder to allow the blade holder to pivot, and in that said bar has a lower profile which is substantially curved without being in contact with an outer peripheral edge of the protruding ring, regardless of the stage of rotation of the drum,
and wherein said bar has on its upper face opposite the lower profile a cutout housing the locking means associated with the blade holder.

6. The device as claimed in claim 1, wherein the blade holder is designed with a first means positioned in a space provided between a last part of the blade and a surface of the bar projecting from an end of the drum,
and wherein the first means is thus located in proximity of a pivot shaft of the blade holder with respect to the bar surface,
and wherein the first means is designed to permit, on one hand, the outward movement of the cutting blade by interaction with the profile and the protuberances in particular, and inward return of the blade after the cut, being locked in position in the cutout formed in the bar surface.

7. The device as claimed in claim 6, wherein a first, leading protuberance of the first means has a triangular configuration, while a second, trailing, protuberance has a pointed shape and is in a specified ratio of height of the order of 1 to 5,
and wherein the first means has an appendage whose height is such that it projects beyond a plane of the blade holder, said appendage having at its upper end a crank oriented perpendicularly to a plane of the lever and facing the cutout formed in the bar and constituting the locking means.

8. The device as claimed in claim 4, wherein the ring of the third means has a non-circular profile with three sectional areas XY, YZ, ZX, permitting passage of the part in different stages of operation and having different configurations, a first area XY being regularly circular, a second area YZ having an amplitude and eccentricity, and a third area ZX providing a decrease and connection to the first area,
and wherein a peak point Z is located in an extension of a second of the protuberances.

9. The device as claimed in claim 8, wherein the first area XY covers an angular sector of the order of 148°, the second area YZ covers a sector of the order of 118° and the third area ZX covers a sector of the order of 94°.

10. The device as claimed in claims 1, wherein the flange is provided with a central void on its exterior.
